(19) United States
(12) Patent Application Publication
(10) Pub. No.: US 2019/0278840 A1
(43) Pub. Date: Sep. 12, 2019

(54) INFORMATION PROCESSING APPARATUS, INFORMATION PROCESSING METHOD, AND INFORMATION PROCESSING PROGRAM

(71) Applicant: OMRON Corporation, Kyoto-shi (JP)

(72) Inventors: Yasumasa SASANO, Kyoto-shi (JP); Naoki SHIBUTANI, Kyoto-shi (JP); Yusuke AKINO, Kyoto-shi (JP)

(73) Assignee: OMRON Corporation, Kyoto-shi (JP)

(21) Appl. No.: 16/299,230

(22) Filed: Mar. 12, 2019

(30) Foreign Application Priority Data
Mar. 12, 2018 (JP) 2018-043731

(51) Int. Cl. G06F 17/27; G06F 16/31; G06F 16/335

(52) U.S. Cl. CPC G06F 17/276; G06F 16/337; G06F 16/313

(57) ABSTRACT

An information processing apparatus includes an input log storage unit, an interest information prediction unit, a relevant information obtaining unit, and a relevant information output unit. The input log storage unit stores an input log of text data for a predetermined application. The interest information prediction unit predicts, from the input log of the text data, interest information to interest an individual user or a user group that has input the text data. The relevant information obtaining unit obtains relevant information relevant to the interest information. The relevant information output unit outputs the relevant information.

### CROSS-REFERENCE TO RELATED APPLICATION

This application claims priority to Japanese Patent Application No. 2018-043731 filed on Mar. 12, 2018, the contents of which are incorporated herein by reference.

### FIELD

The disclosure relates to a technique for providing an output appropriate to user interest.

### BACKGROUND

A variety of information processing apparatuses use data input interfaces such as Input Method Editors (IMEs), which allow users to enter intended words through a combination of input keys. A data input interface such as an IME extracts autocomplete suggestions based on a combination of input characters.

Nowadays, various techniques have been developed to provide information to a user through an interactive interface as described in, for example, Patent Literature 1.

### CITATION LIST

### Patent Literature

Patent Literature 1: Japanese Unexamined Patent Application Publication No. 2004-343320

### SUMMARY

### Technical Problem

Data input interfaces provide appropriate autocomplete suggestions predicted by artificial intelligence (AI) or based on the frequency of occurrence (frequency of input). However, such interfaces cannot easily provide appropriate autocomplete suggestions for words with, for example, a low frequency of past input although the user is interested in the words.

Likewise, interactive interfaces cannot easily provide appropriate information with insufficient interaction although the user is interested in the information.

One or more aspects are directed to an information processing technique for providing an output appropriate to user interest.

### Solution to Problem

An information processing apparatus according to an aspect of the disclosure includes an input log storage unit, an interest information prediction unit, a relevant information obtaining unit, and a relevant information output unit. The input log storage unit stores an input log of text data for a predetermined application. The interest information prediction unit predicts, from the input log of the text data, interest information to interest an individual user or a user group that has input the text data. The relevant information obtaining unit obtains relevant information relevant to the interest information. The relevant information output unit outputs the relevant information.

In this structure, interest information that probably interests the user and relevant information relevant to the interest information are obtained from a large amount of text data and are provided to the user. This increases the accuracy in providing relevant information to the user.

The information processing apparatus according to an aspect of the disclosure further includes a response input unit, a response determination unit, and a prediction criterion adjustment unit. The response input unit receives a user response to the relevant information. The response determination unit determines whether the response indicates interest. The prediction criterion adjustment unit adjusts a criterion for predicting the interest information based on a determination result from the response determination unit, and outputs the criterion to the interest information prediction unit.

In this structure, the criterion for predicting the interest information is updated based on the user response to the relevant information relevant to the interest information. This increases the accuracy in predicting the interest information.

The information processing apparatus according to an aspect of the disclosure further includes an output suggestion determination unit. The output suggestion determination unit determines an output suggestion for input text data. The output suggestion determination unit determines the output suggestion based on the interest information.

In this structure, the output suggestion appropriate to the user interest is obtained. This increases the accuracy in providing output suggestions appropriate to the user.

The information processing apparatus according to an aspect of the disclosure may further include a relevant term obtaining unit. The relevant term obtaining unit obtains a relevant term associated with the interest information based on an adjustment result from the prediction criterion adjustment unit.

In this structure, the relevant term updates the variety of suggestions for interest information. This increases the accuracy in predicting the interest information based on the user response.

### Advantageous Effects

The apparatus according to one or more aspects provides an output appropriate to the user interest.

### BRIEF DESCRIPTION OF THE DRAWINGS

FIG. 1 is a functional block diagram illustrating an information processing apparatus according to one or more embodiments.

FIG. 2 is a flow diagram illustrating a first process with an information processing method according to one or more embodiments.

FIG. 3 is a conceptual diagram illustrating prediction of examples of interest information.

FIG. 4 is a flow diagram illustrating a second process with an information processing method according to one or more embodiments.

FIG. 5 is a flow diagram illustrating a third process with an information processing method according to one or more embodiments.

FIG. 6 is a conceptual diagram illustrating an example process of detailing.

FIG. 7 is a conceptual diagram illustrating an example process of generalizing.

FIG. 8 is a functional block diagram illustrating an information processing apparatus according to a first modification of one or more embodiments.

FIG. 9 is a functional block diagram illustrating an information processing apparatus according to a second modification of one or more embodiments.

### DETAILED DESCRIPTION

Embodiments will now be described with reference to the drawings.

### Example Use

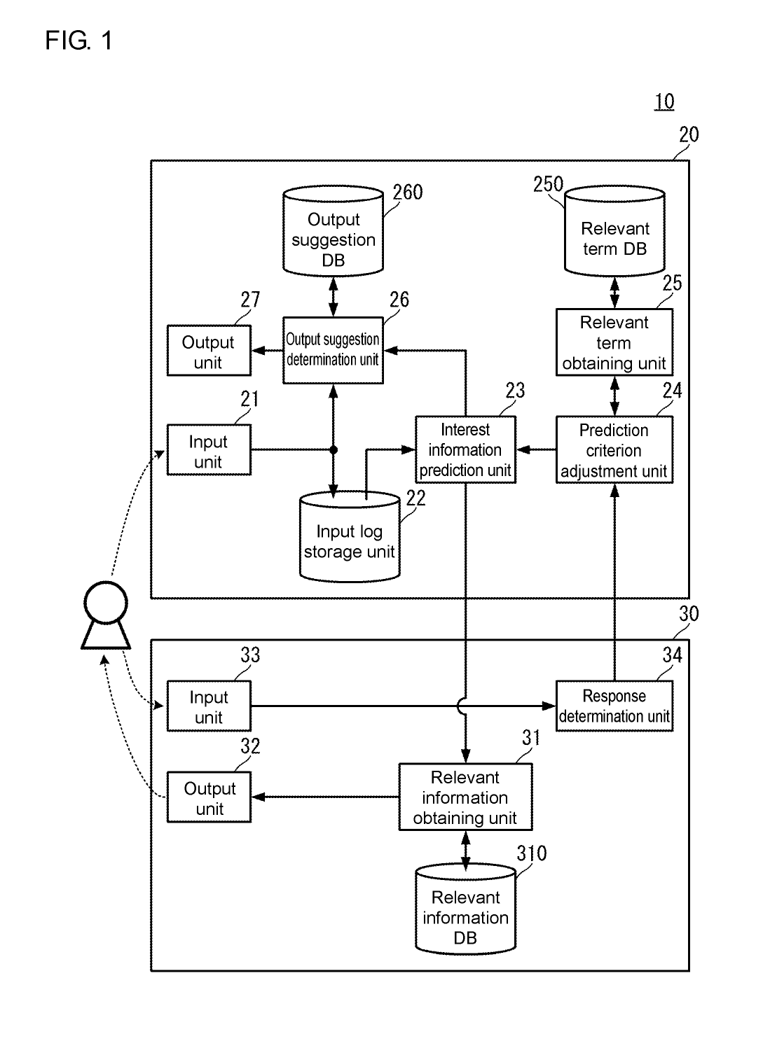

An example use of an information processing apparatus according to embodiments will be described first with reference to FIG. 1. FIG. 1 is a functional block diagram of an information processing apparatus according to one or more embodiments.

An information processing apparatus 10 includes a first processing unit 20 and a second processing unit 30. The first processing unit 20 mainly has a data input interface function. The data input interface function refers to, for example, outputting autocomplete suggestions for text data such as characters input by a user through a predetermined application. The second processing unit 30 mainly has an interactive interface function. The interactive interface function refers to interactively providing information to the user.

The first processing unit 20 includes at least an input log storage unit 22, an interest information prediction unit 23, and a prediction criterion adjustment unit 24. The second processing unit 30 includes a relevant information obtaining unit 31 and a response determination unit 34.

The input log storage unit 22 stores an input log of text data from the user. More specifically, the input log storage unit 22 stores text data sets that have been input in the past.

The interest information prediction unit 23 predicts the interest information from the text data sets using a prediction technique such as artificial intelligence (AI) or the frequency of occurrence (frequency of input) of the same text data.

Based on the interest information, the relevant information obtaining unit 31 obtains relevant information relevant to the interest information.

The response determination unit 34 determines whether a user response indicates interest in the relevant information relevant to the interest information.

Based on the determination result from the response determination unit 34, the prediction criterion adjustment unit 24 adjusts the criterion for predicting the interest information.

The interest information prediction unit 23 predicts the interest information using the prediction criterion updated by the prediction criterion adjustment unit 24.

With the configuration and the processing described above, the second processing unit 30 enables the interactive interface function to provide, to the user, information appropriate to the user interest. The above processing is repeated to exponentially increase the accuracy of the information.

With the configuration and the processing described above, the first processing unit 20 enables the data input interface function to provide, to the user, the output appropriate to the user interest. The above processing is repeated to exponentially increase the accuracy of the output.

### Example Structure

The information processing technique according to one or more embodiments will be described with reference to the drawings. As described above, FIG. 1 is a functional block diagram of an information processing apparatus according to one or more embodiments.

As shown in FIG. 1, the information processing apparatus 10 includes the first processing unit 20 and the second processing unit 30. The information processing apparatus 10 may be a personal computer, a mobile information communication terminal, or another device including computing elements such as a central processing unit (CPU) and a micro processing unit (MPU), and a storage medium storing programs for implementing the processing in the first processing unit 20 and the second processing unit 30. The computing elements execute the programs to implement the processing performed by the first processing unit 20 and the second processing unit 30.

As described above, the first processing unit 20 enables the data input interface function. For example, the first processing unit 20 enables the Input Method Editor (IME) function.

As described above, the second processing unit 30 enables the interactive interface function. For example, the second processing unit 30 enables a chatbot function.

The function of the first processing unit 20 is linked with the function of the second processing unit 30. The first processing unit 20 and the second processing unit 30 mutually support data through the processing described later.

The first processing unit 20 includes at least the input log storage unit 22 and the interest information prediction unit 23. The first processing unit 20 includes the prediction criterion adjustment unit 24, and also an input unit 21, a relevant term obtaining unit 25, an output suggestion determination unit 26, an output unit 27, a relevant term database (relevant term DB) 250, and an output suggestion database (output suggestion DB) 260.

The second processing unit 30 includes at least the relevant information obtaining unit 31 and an output unit 32. The second processing unit 30 includes an input unit 33 and the response determination unit 34. The second processing unit 30 further includes a relevant information database (relevant information DB) 310. Configuration and Processing of First Processing Unit 20

The input unit 21 is, for example, a keyboard or a software keyboard. The input unit 21 receives an input from an individual user or a user group. The input unit 21 generates text data based on the input and outputs the text data to the input log storage unit 22. The input unit 21 also outputs the text data to the output suggestion determination unit 26.

The input log storage unit 22 is a predetermined nonvolatile storage medium. The input log storage unit 22 may be a storage external to the information processing apparatus 10. The input log storage unit 22 stores input logs of text data from the input unit 21. In other words, the input log storage unit 22 stores historical text data from the input unit 21. The input log storage unit 22 thus stores large volumes of text data sets.

The interest information prediction unit 23 predicts the interest information using the input logs, or specifically the text data sets. More specifically, the interest information prediction unit 23 predicts the interest information from the text data sets using a prediction technique such as AI or the frequency of occurrence (frequency of input) of the same text data. The interest information is obtained as, for example, text data.

The interest information has a predetermined granularity, which is adjustable. The granularity refers to the number of classified types of the interest information. A coarser granularity provides fewer classified types of interest information, whereas a finer granularity provides more classified types of interest information.

The interest information prediction unit 23 in the early stages predicts the interest information with a coarse granularity. The interest information prediction unit 23 outputs the predicted interest information to the relevant information obtaining unit 31 in the second processing unit 30. The interest information prediction unit 23 also outputs the predicted interest information to the output suggestion determination unit 26.

The prediction criterion adjustment unit 24 obtains response data indicating whether the user is interested in the interest information from the response determination unit 34 in the second processing unit 30. Based on the response data, the prediction criterion adjustment unit 24 adjusts the criterion for predicting the interest information. More specifically, when obtaining response data that indicates interest, the prediction criterion adjustment unit 24 details the criterion for predicting the interest information.

In other words, when obtaining response data that indicates interest, the prediction criterion adjustment unit 24 adjusts the prediction criterion for the interest information prediction unit 23 to have a finer granularity. In contrast, when obtaining response data that indicates no interest, the prediction criterion adjustment unit 24 either generalizes the criterion for predicting the interest information or changes the criterion.

The relevant term obtaining unit 25 obtains a relevant term from the relevant term database 250 based on the prediction criterion adjusted by the prediction criterion adjustment unit 24. The relevant term obtaining unit 25 outputs the obtained relevant term to the prediction criterion adjustment unit 24. The prediction criterion adjustment unit 24 outputs the relevant term to the interest information prediction unit 23.

The interest information prediction unit 23 obtains and uses the relevant term as a criterion for predicting the interest information. For example, the interest information prediction unit 23 predicts the interest information based on the matching frequency with the relevant term.

The output suggestion determination unit 26 determines an output suggestion for the input text data. More specifically, the output suggestion determination unit 26 retrieves an output suggestion from the output suggestion database (output suggestion DB) 260 with a known technique.

The output suggestion determination unit 26 also determines the output suggestion based on the interest information obtained from the interest information prediction unit 23. This process increases the accuracy in providing the output suggestion for the information intended by the user.

For the first processing unit 20 that operates as an IME, for example, the output suggestion determination unit 26 determines an autocomplete suggestion for the input text data. The configuration and the processing described above increase the accuracy in providing the autocomplete suggestion for the word intended by the user.

The output unit 27 is an output suggestion display area defined on the display of the information processing apparatus 10, and outputs the output suggestion.

Configuration and Processing of Second Processing Unit 30

The relevant information obtaining unit 31 obtains relevant information relevant to the interest information from the relevant information database (relevant information DB) 310 using a known technique such as AI. The relevant information is not the interest information itself, but is other information including information relevant to the interest information. In a specific example, the interest information may be soccer. In this example, the relevant information includes soccer news and a blog or a social networking service (SNS) about soccer. The relevant information is obtained as, for example, text data.

The output unit 32 is an information display area defined on the display of the information processing apparatus 10. The output unit 32 outputs and provides the relevant information to the user. The output unit 32 is an example of a relevant information output unit in one or more embodiments.

The input unit 33 is, for example, a keyboard or a software keyboard, like the input unit 21. The input unit 33 receives text data representing a user response to the relevant information output from the output unit 32. The input unit 33 outputs the response text data to the response determination unit 34.

The response determination unit 34 determines the user response based on the response text data using a known technique such as AI. The user response is either a response indicating interest or a response indicating no interest. The response determination unit 34 outputs the response determination result to the prediction criterion adjustment unit 24.

With the configuration and the processing described above, the second processing unit 30 enables the interactive interface function to provide a topic to the user based on large volumes of text data sets from the first processing unit 20. The second processing unit 30 can thus provide a topic appropriate to the user interest with high accuracy. In addition, the user response about interest can be fed back to the first processing unit 20 to increase the accuracy of the interest information predicted by the first processing unit 20.

### Specific Processing Examples

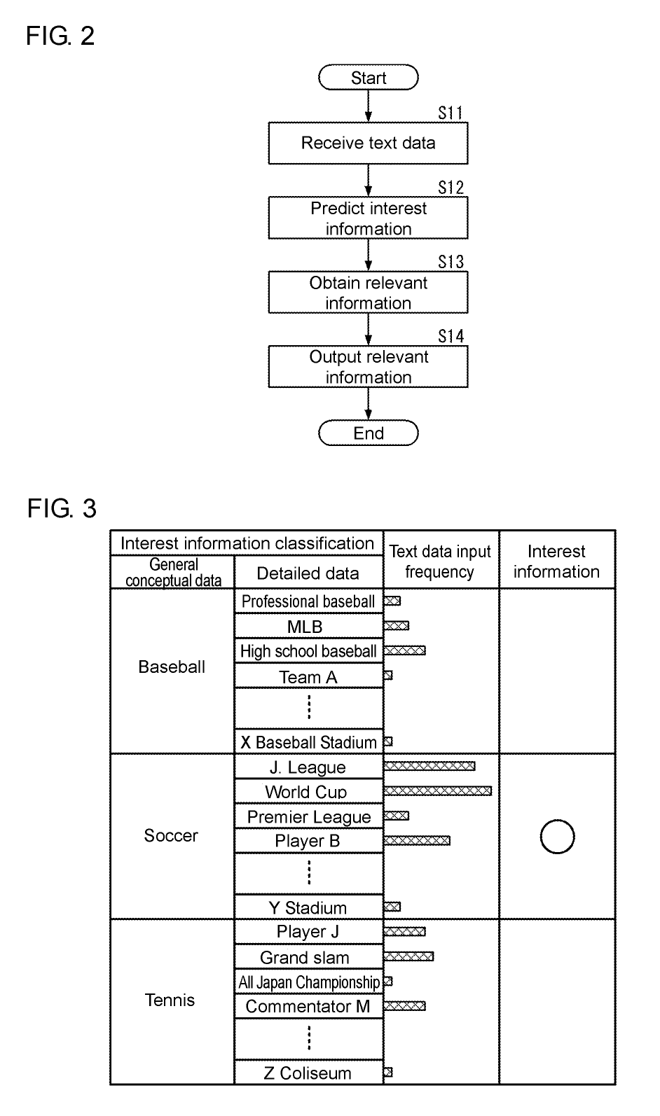

FIG. 2 is a flowchart showing a first process with an information processing method according to one or more embodiments. FIG. 3 is a conceptual diagram of prediction of examples of interest information.

As shown in FIG. 2, the first processing unit 20 in the information processing apparatus 10 receives text data (S11). The first processing unit 20 predicts the interest information from the historical text data sets received in the past (S12). The technique for predicting the interest information is described above. For example, the interest information is predicted as described below.

As shown in FIG. 3, the interest information is classified into, for example, general conceptual data and detailed data. The general conceptual data is based on coarse granularity classification. The detailed data is based on fine granularity classification. Although FIG. 3 shows the two levels, the interest information may be classified into three or more levels depending on the granularity.

For example, the general conceptual data in FIG. 3 includes baseball, soccer, and tennis. The detailed data relevant to baseball in the general conceptual data includes professional baseball, Major League Baseball (MLB), high school baseball, team A, . . . , and X Baseball Stadium. The detailed data relevant to soccer in the general conceptual data includes J. League, World Cup, Premier League, player B, . . . , and Y Stadium. The detailed data relevant to tennis in the general conceptual data includes player J, grand slam, All Japan Championship, commentator M, . . . , and Z Coliseum.

For example, the first processing unit 20 obtains, for each detailed data item, the frequency of occurrence (frequency of input) of the text data. The first processing unit 20 totals the frequencies of occurrence of the detailed data for each general conceptual data item to obtain the frequency of occurrence of each general conceptual data item. The first processing unit 20 determines, for example, the general conceptual data with the highest frequency of occurrence as the interest information.

In the example of FIG. 3, soccer has the highest frequency of occurrence among baseball, soccer, and tennis as the general conceptual data, and thus soccer is determined as the interest information.

The second processing unit 30 obtains relevant information based on the interest information (S13). The technique for obtaining the relevant information is also described above.

For example, when receiving the results shown in FIG. 3, the second processing unit 30 obtains relevant information relevant to soccer, which is the interest information. More specifically, the second processing unit 30 obtains soccer news, a soccer article posted on a web page (e.g., a blog or an SNS), and other soccer information as relevant information.

The second processing unit 30 outputs the relevant information (S14).

In this manner, the information processing apparatus 10 provides the relevant information relevant to the interest information to the user. The interest information in this case is based on a large volume of text data received by the first processing unit 20. Thus, the interest information appropriate for the user can be provided with high accuracy, without sufficient interaction through the interactive interface provided by the second processing unit 30.

The information processing apparatus 10 provides the relevant information relevant to the interest information to the user, rather than providing the interest information to the user. In other words, the user receives the interest information indirectly, rather than directly. This allows the information processing apparatus 10 to provide a topic to the user without creating an unfavorable impression on the interactive interface, and also obtain a response to the interest information.

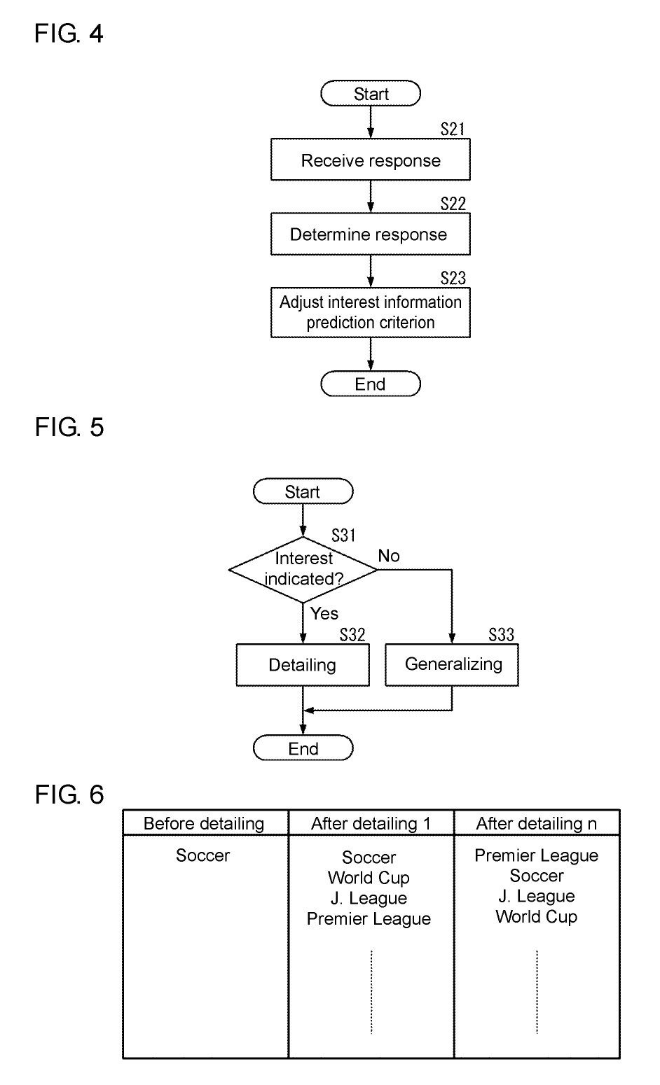

FIG. 4 is a flowchart showing a second process with the information processing method according to one or more embodiments.

As shown in FIG. 4, the second processing unit 30 in the information processing apparatus 10 receives a response to the relevant information relevant to the interest information provided in the first processing (S21).

The second processing unit 30 determines the response, or more specifically, whether the user is interested in the interest information (S22). For example, the second processing unit 30 analyzes the text data of the received response to determine whether the response indicates interest or no interest.

The first processing unit 20 in the information processing apparatus 10 uses the response determination result to adjust the criterion for predicting the interest information (S23).

FIG. 5 is a flowchart showing a third process with the information processing method according to one or more embodiments. The third process is an example of processing with the method of adjusting the criterion for predicting the interest information.

When determining that the user has interest based on the response determination result (Yes in S31), the first processing unit 20 details the prediction criterion (S32). Detailing the prediction criterion refers to setting a finer granularity. In the example shown in FIG. 3, detailing refers to including the detailed data into the interest information, in addition to the general conceptual data.

For example, FIG. 6 is a conceptual diagram of an example process of such detailing. As shown in FIG. 6, the interest information is predicted to be soccer in the general conceptual data in the early stages. The detailing is repeated to predict the interest information to include detailed data items such as World Cup, J. League, and Premier League, in addition to soccer as the general conceptual data. In this state, for example, the accuracy of each prediction may be defined, and may be used to prioritize each prediction to be output in the order of higher accuracy (descending order in FIG. 6) to the relevant information obtaining unit 31. In this case, the detailing may further be repeated to adjust the priorities of output (descending order in FIG. 6) to the relevant information obtaining unit 31 as shown in FIG. 6.

When determining that the user has no interest based on the response determination result (No in S31), the first processing unit 20 generalizes the prediction criterion (S33). Generalizing the prediction criterion refers to setting a coarser granularity, or using other data as the interest information without changing the granularity.

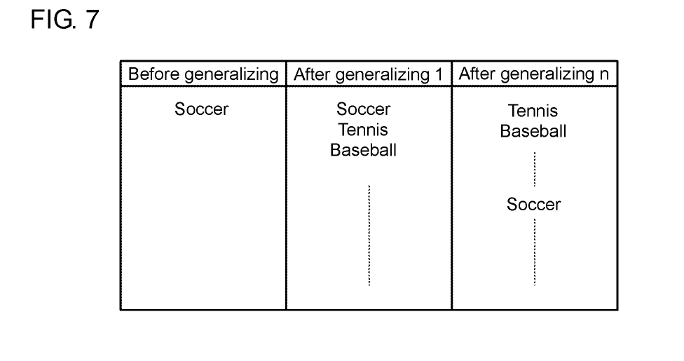

For example, FIG. 7 is a conceptual diagram of an example process of such generalizing. As shown in FIG. 7, the interest information is predicted to be soccer in the general conceptual data in the early stages. The generalizing is repeated to predict the interest information to include general conceptual data items such as tennis and baseball, in addition to soccer as the same general conceptual data. In this state, for example, the accuracy of each prediction may be defined, and may be used to prioritize each prediction to be output in the order of higher accuracy (descending order in FIG. 7) to the relevant information obtaining unit 31. In this case, the generalizing may further be repeated to adjust the priorities of output (descending order in FIG. 7) to the relevant information obtaining unit 31 as shown in FIG. 7.

Although either detailing or generalizing is repeated in the examples described above, detailing and generalizing may be combined.

This information processing apparatus 10 can predict the interest information with higher accuracy based on a user response. For example, the information processing apparatus 10 may repeat the above processing to accurately predict the interest information as a word with a low frequency of occurrence.

The first processing unit 20 may use the relevant term obtaining unit 25 to obtain a new word as a possible suggestion for interest information based on the response determination result. This modification increases the variety of suggestions for interest information through detailing or generalizing.

Modifications

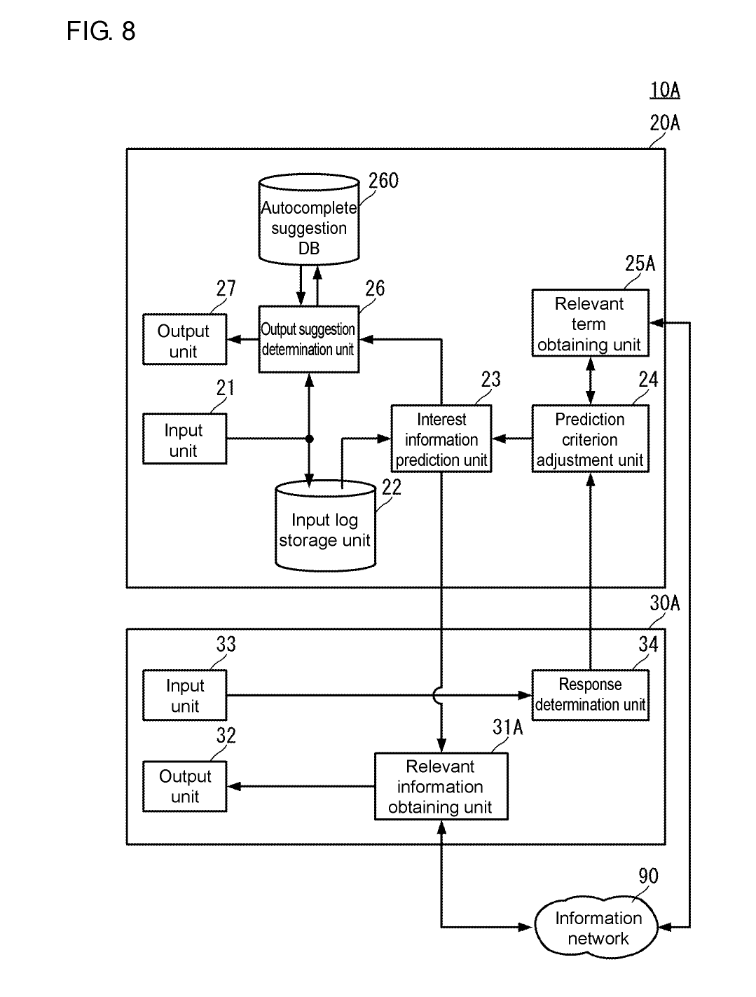

FIG. 8 is a functional block diagram of an information processing apparatus according to a first modification of one or more embodiments. As shown in FIG. 8, an information processing apparatus 10A differs from the information processing apparatus 10 in that a first processing unit 20A includes a relevant term obtaining unit 25A and a second processing unit 30A includes a relevant information obtaining unit 31A. The other components of the information processing apparatus 10A are the same as those of the information processing apparatus 10, and will not be described.

The relevant term obtaining unit 25A and the relevant information obtaining unit 31A are connected to an information network 90. The relevant information obtaining unit 31A obtains relevant information relevant to interest information through the information network 90. The relevant term obtaining unit 25A obtains a term relevant to interest information through the information network 90.

The configuration and the processing allow a larger variety of relevant information and relevant terms to be obtained. The information processing apparatus 10A can thus predict the interest information with higher accuracy and provide a topic more appropriate to the interest information.

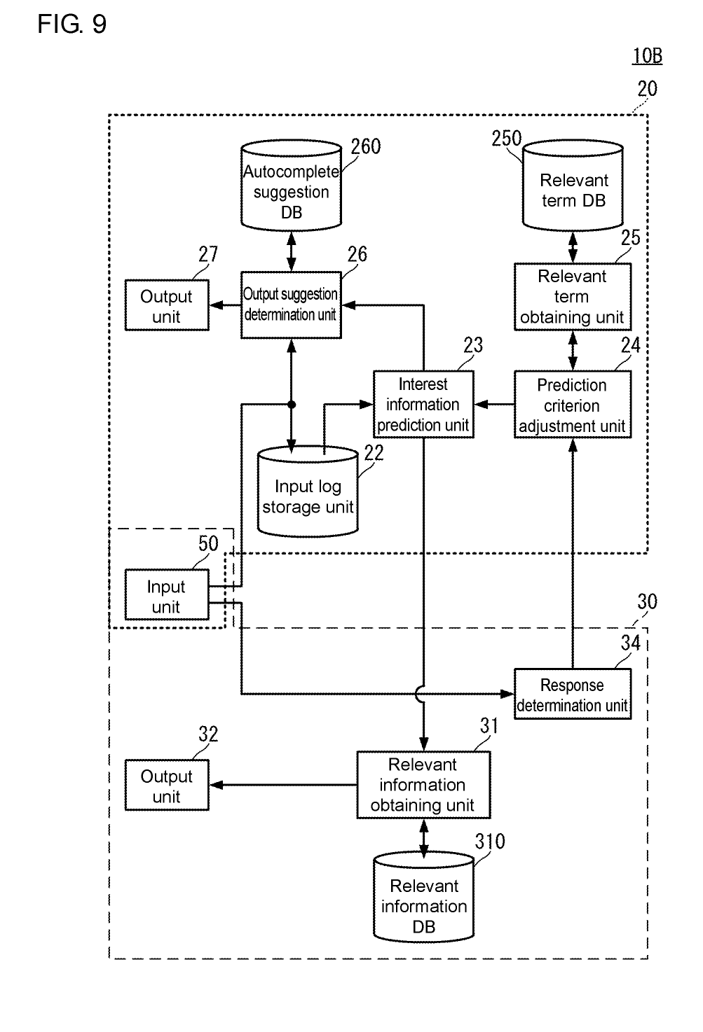

FIG. 9 is a functional block diagram of an information processing apparatus according to a second modification of one or more embodiments. As shown in FIG. 9, an information processing apparatus 10B differs from the information processing apparatus 10 in that the first processing unit 20 and the second processing unit 30 share an input unit 50. The other components of the information processing apparatus 10B are the same as those of the information processing apparatus 10, and will not be described.

This configuration produces the same advantageous effects as the information processing apparatus 10. Additionally, the information processing apparatus 10B includes fewer components.

Although predicting and detailing the interest information have been described above, the above configuration may also be used to avoid a field in which the user is uninterested.

The information processing apparatus includes the input log storage unit 22 in one or more embodiments. In some embodiments, the text data sets from which the interest information is predicted may be obtained from a database associated with the user on a network.

In one or more embodiments, text data is input and output. In some embodiments, voice based on text data may be input and output, or an object corresponding to text data (for example, a Like button) may be operated.

In one or more embodiments, interest information is represented as text data. In some embodiments, interest information may be represented as any other data indicating user interest. For example, such data may include an interest information ID, an interest information binary string, a uniform resource locator (URL) including a reference to interest information, a C structure representing interest information, or a real number array representing a combination of interest information items generated using a technique such as deep learning.

Detailing and generalizing described in one or more embodiments may also be achieved by deep learning.

1. An information processing apparatus, comprising:
an input log storage medium configured to store an input log of text data for a predetermined application; and
a processor configured with a program to perform operations comprising:
operation as an interest information prediction unit configured to predict, from the input log of the text data, interest information to interest an individual user or a user group that input the text data;
operation as a relevant information obtaining unit configured to obtain relevant information relevant to the interest information; and
operation as a relevant information output unit configured to output the relevant information.

2. The information processing apparatus according to claim 1, wherein the processor is configured with the program to perform operations further comprising:
operation as a response input unit configured to receive a user response to the relevant information;
operation as a response determination unit configured to determine whether the user response indicates interest; and
operation as a prediction criterion adjustment unit configured to adjust a criterion for predicting the interest information based on a determination result from the response determination unit, and output the criterion to the interest information prediction unit.

3. The information processing apparatus according to claim 2, wherein the processor is configured with the program to perform operations further comprising operation as an output suggestion determination unit configured to determine an output suggestion for input text data based on the interest information.

4. An information processing apparatus, comprising:
a processor configured with a program to perform operations comprising:
operation as a relevant information output unit configured to output relevant information relevant to interest information predicted to interest an individual user or a user group;
operation as a response input unit configured to receive a user response to the relevant information;
operation as a response determination unit configured to determine whether the response indicates interest; and
operation as a prediction criterion adjustment unit configured to adjust a criterion for predicting the interest information based on a determination result from the response determination unit.

5. The information processing apparatus according to claim 2, wherein the processor is configured with the program to perform operations further comprising operation as a relevant term obtaining unit configured to obtain a relevant term associated with the interest information based on an adjustment result from the prediction criterion adjustment unit.

6. The information processing apparatus according to claim 3, wherein the processor is configured with the program to perform operations further comprising operation as a relevant term obtaining unit configured to obtain a relevant term associated with the interest information based on an adjustment result from the prediction criterion adjustment unit.

7. The information processing apparatus according to claim 4, wherein the processor is configured with the program to perform operations further comprising operation as a relevant term obtaining unit configured to obtain a relevant term associated with the interest information based on an adjustment result from the prediction criterion adjustment unit.

8. An information processing method, comprising:
storing an input log of text data for a predetermined application;
predicting, from the input log of the text data, interest information to interest an individual user or a user group that has input the text data;
obtaining relevant information relevant to the interest information;
outputting the relevant information;
receiving a user response to the relevant information;
determining whether the response indicates interest; and
adjusting a criterion for predicting the interest information based on a determination result of the response.

9. A non-transitory computer-readable storage medium storing an information processing program, which when read and executed, causes a processor of an information processing apparatus to perform operations comprising:
storing an input log of text data for a predetermined application;
predicting, from the input log of the text data, interest information to interest an individual user or a user group that has input the text data;
obtaining relevant information relevant to the interest information;
outputting the relevant information;
receiving a user response to the relevant information;
determining whether the response indicates interest; and
adjusting a criterion for predicting the interest information based on a determination result of the response.
